(19) United States
(12) Patent Application Publication
(10) Pub. No.: US 2005/0246279 A1
(43) Pub. Date: Nov. 3, 2005

(54) Provision of graphic designs

(76) Inventor: Melvyn Stamelman, JOHANNESBURG (ZA)

Correspondence Address: LADAS & PARRY, 26 WEST 61ST STREET, NEW YORK, NY, 10023, US

(21) Appl. No.: 10/508,096

(22) PCT Filed: Mar. 17, 2003
(86) PCT No.: PCT/IB03/00957

§ 371 Date: Jun. 10, 2005

(30) Foreign Application Priority Data
Mar. 15, 2002 (ZA) 2002/2156

(51) Int. Cl. H04K 1/00; H04L 9/00; G06F 17/60

(52) U.S. Cl. 705/51; 705/57

(57) ABSTRACT

The invention provides for the use of equipment (10), more specifically a computer system, to supply a design to a client, such as a potential user thereof. According to the invention, a design provider associates a use deterring mark with the design and transmits the design together with the use deterring mark via the internet from his server computer (14) to a client computer (12) of the potential user, for approval. The invention provides for a method of supplying a design to a potential user, a system for performing the said method, a server computer (14) connectable to a client computer (12) through a network which includes an ordering means whereby a potential user of a design may communicate with a design provider and a server computer (14) connectable to a client computer which includes a facility for a designer to apply for appointment as a designer for the design provider.

### TECHNICAL BACKGROUND

This invention relates to the provision of designs. More particularly, it relates to equipment for supplying a design to a potential user thereof, a computer system for supplying a design to a potential user, a method of supplying a design to a potential user, a system for performing the said method, a server computer connectable to a client computer through a network which includes an ordering means whereby a potential user of a design may communicate with a design provider and a server computer connectable to a client computer which includes a facility for a designer to apply for appointment as a designer for the design provider.

The design may be a picture, decorative lettering, a visual pattern, and the like, and may include graphic designs such as logos, personalised stationery, advertising material, presentation material, packaging and the like.

### DESCRIPTION OF THE INVENTION

In this specification “use deterring mark” shall mean a mark which is associated with a design to deter unauthorised use of the design by potential users thereof.

According to a first aspect of the invention there is provided equipment for supplying a design by a design provider to a potential user thereof, which includes:
an associating means for associating with the design a mark to deter unauthorised use of the design by potential users thereof; and
a transmitting means for transmitting the design together with the associated use deterring mark to the potential user.

The design may be provided by a design provider who himself designed the design or the design may be provided by a design provider who is not the designer of the design.

The equipment may include a computer. More specifically, the design provider may have a computer and the potential user, or an intermediary who receives the design for onward forwarding to the potential user, may also have a computer, the said computers being linked by way of a computer network.

As stated above, the design provider may be a designer who creates the design.

Alternatively, the designer may create the design which he then conveys to the design provider, who thereafter transmits the design to the potential user or the intermediary. The designer may have a computer which may also be linked to the design provider's computer by the computer network.

The transmitting means may include computer hardware and software located on the design provider's computer to enable the design provider to transmit the design via the computer network to the computer of the potential user or the intermediary.

The associating means may include a computer program, which may be run on the design provider's computer.

According to a second aspect of the invention there is provided a computer system for supplying a design to a potential user by means of a computer network, which system includes
an associating means for associating with the design a mark to deter unauthorised use of the design by the potential user; and
a transmitting means for transmitting the design together with the use deterring mark to the potential user for approval.

The design may be provided by a design provider who himself designed the design or the design may be provided by a design provider who is not the designer of the design.

The computer system may include a computer for the design provider as well as a computer for the potential user, or an intermediary who receives the design for onward forwarding to the potential user, the said computers being linked by way of a computer network.

The computer network may be the internet.

The transmitting means may be hardware and software located on the design provider's computer to enable the design provider to transmit the design via the computer network to the computer of the potential user or the intermediary.

The associating means may include a computer program.

The computer system may include an ordering means whereby the potential user may forward details of an order for the design to the designer provider's computer by means of the computer network. The ordering means may include suitable hardware and software located on the design provider's computer to enable the potential user to forward the details of the order via the computer network to the designer provider's computer.

Further, if the design provider is not the designer, the computer system may include a communicating means for communicating the details of the order for the design from the design provider to the designer. The communicating means may be computer software and hardware located on the computer of the design provider to enable the design provider to communicate the details of the order via the computer network to the designer's computer. The designer may have conveying means to convey the resulting design to the design provider. The conveying means may include computer hardware and software located on the designer's computer to enable the designer to convey the design to the design provider's computer via the computer network.

The computer system may include a payment facility whereby the potential user or the intermediary may make payment for the design.

According to a third aspect of the invention there is provided a method of supplying a design to a potential user thereof, which includes the steps of:
associating with the design a mark to deter unauthorised use of the design by potential users thereof; and
transmitting the design together with the use deterring mark to the potential user for approval.

The method may include the steps of
disassociating the use deterring mark from the design by an authorised person once the potential user has paid for the design; and
transmitting to the potential user the design without the use deterring mark.

The design may be provided by a design provider who himself designed the design or the design provider may use a designer to provide the design.

The potential user may forward details of an order for the design by means of a computer network, which may for example be the internet, to the design provider, who may in turn communicate, by means of the computer network, the details of the order to the designer. The details of the order may be encrypted before it is forwarded over the computer network by means of existing electronic encryption techniques.

The designer may convey the design to the design provider by means of the computer network and the design provider may then transmit the design to the potential user by means of the computer network. Alternatively, the designer may transmit the design directly to the potential user by means of the computer network.

The design and use deterring mark may be transmitted directly to the potential user or via an intermediary.

The intermediary may be a retailer such as, for example, a stationer, an internet café, or a print and photocopy shop. The retailer may receive a commission from the design provider which may be calculated as a percentage of the value of the design. Alternatively, the potential user may pay the retailer who in turn pays the design provider, with the retailer receiving a discount on the price by the design provider.

The use deterring mark may be disassociated from the design by an authorised person (who will usually be the design provider) once the potential user has paid for the design, and the design from which the use deterring mark has been disassociated may then be transmitted via the computer network to the potential user. It will be appreciated that the use deterring mark should be difficult for an unauthorised person to remove from the design but easy for an authorised person to remove from the design.

According to a fourth aspect of the invention there is provided a system for performing the method as described above, which includes a data signal comprising
a first set of data elements incorporating the design; and

a second set of data elements incorporating the use deterring mark.

According to a fifth aspect of the invention there is provided a server computer connectable to a client computer through a computer network, which includes an ordering means whereby a potential user of a design may communicate with a design provider.

The ordering means may include computer hardware and software located on the server computer to enable the potential user to communicate with the server computer via the computer network.

According to a sixth aspect of the invention there is provided a server computer connectable to a client computer which includes a facility for a designer to apply for appointment as a designer for a design provider.

The facility may include an information providing means which may be an interactive web page on a web site. The said web page may have input fields, selection boxes, toggling check boxes, and the like, where the designer may enter his personal details. The facility may also include an electronic file providing means to enable the designer to scan documents and attach electronic files, for example curriculum vitae, portfolios, digitised artwork and photographs.

According to a further aspect of the invention there is provided a web site hosted by a host computer which includes an information supplying means whereby a potential user of a design may supply information to a design provider via a computer network.

The information supplying means may include an interactive web page on the web site which means may include input fields, selection boxes and toggling check boxes, and the like. The potential user may furnish her personal details and the details of her design order by typing the details in input fields, choosing appropriate options from one or more selection boxes each containing a plurality of options and clicking on toggling check boxes representing desired options. The potential user may also provide images which are to be included in the design by attaching electronic files or by electronically scanning the images and attaching the electronic files generated by such scanning. The electronic files containing images in electronic format are then communicated to the design provider's computer by means of the computer network. The design provider's website may have instructions regarding the method to be followed by the potential user to provide images to the design provider.

The web site may also provide information about the design provider, the services provided by it (which may include samples of work done by the design provider) and the cost of the designs. It may also provide the terms and conditions upon which the design provider is prepared to do business and may include a “click” button or the like by which the potential user may signify her consent to the terms and conditions.

The web site may further provide a web page for retailers and other potential business associates to enter their contact details in order to obtain further information from the design provider.

The information provided by potential design users, retailers and potential business associates may be encrypted by means of existing electronic encryption devices.

According to a still further aspect of the invention there is provided a computer server on which there is provided a web site as described above.

### BRIEF DESCRIPTION OF THE ACCOMPANYING ILLUSTRATIONS

The invention will now be described, by way of example, with reference to the accompanying illustrations.

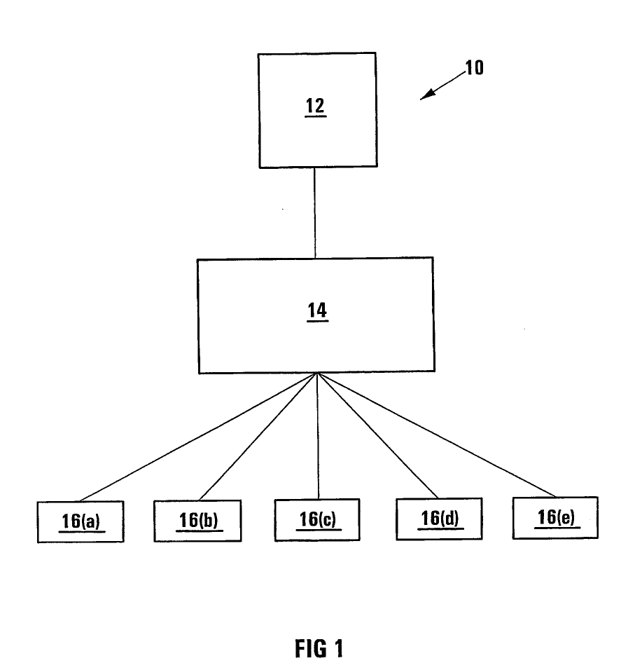

FIG. 1 is a diagrammatic drawing showing equipment, more specifically a computer system, to supply a design in accordance with the invention.

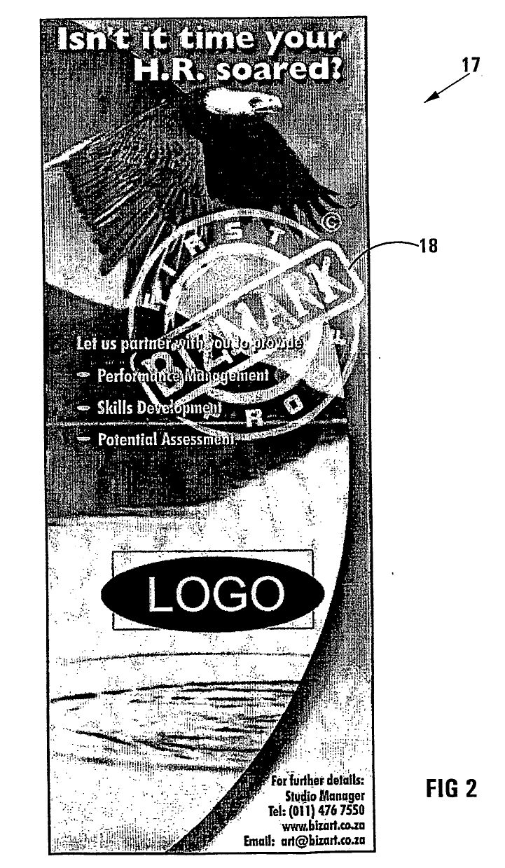

FIG. 2 is an illustration of a design associated with a use deterring mark in accordance with the invention;

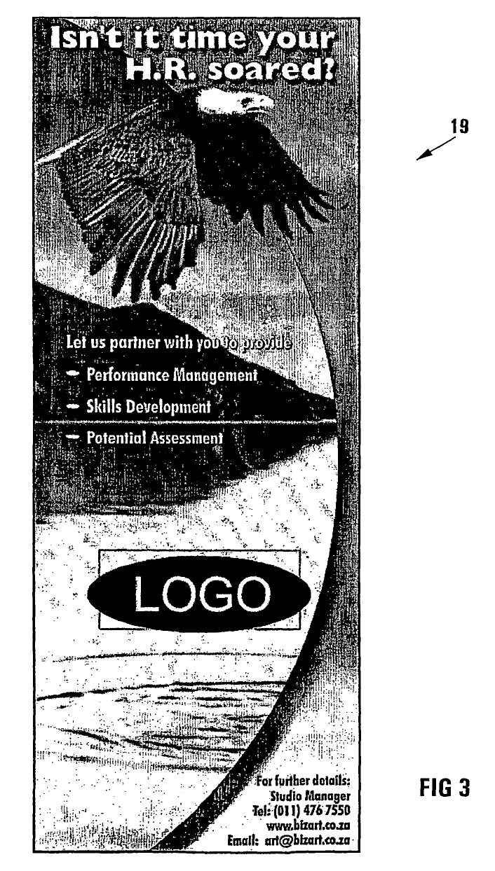

FIG. 3 is an illustration of the design of FIG. 2 without the associated use deterring mark;

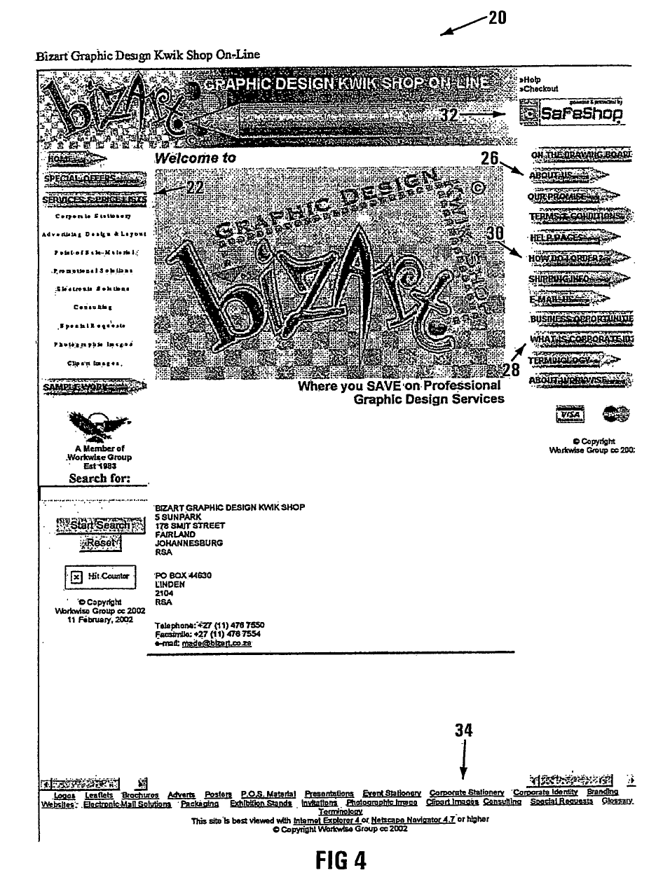

FIG. 4 is a representation of a home web page of a web site in accordance with the invention;

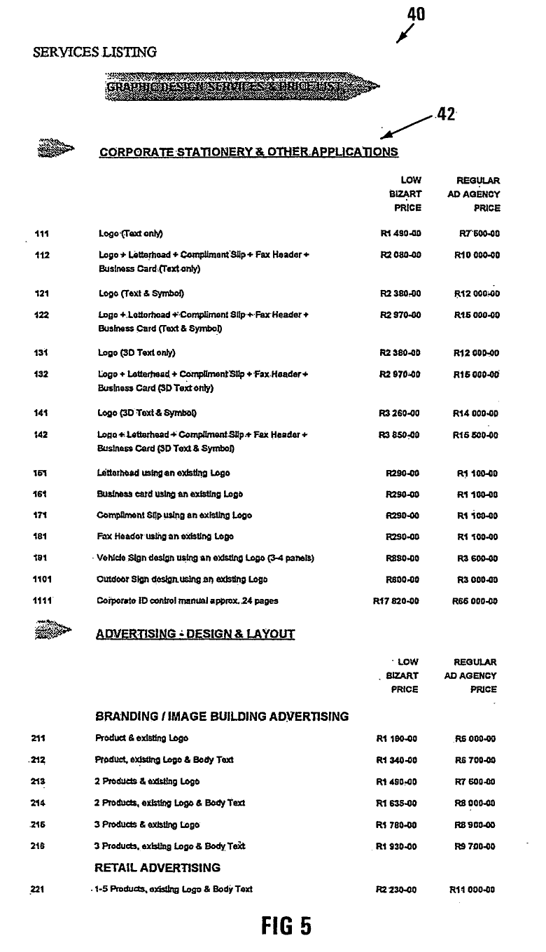

FIG. 5 is a representation of a web page of the web site, which page is entitled “Graphic Design Services & Price List” and is linked to the home web page represented in FIG. 4;

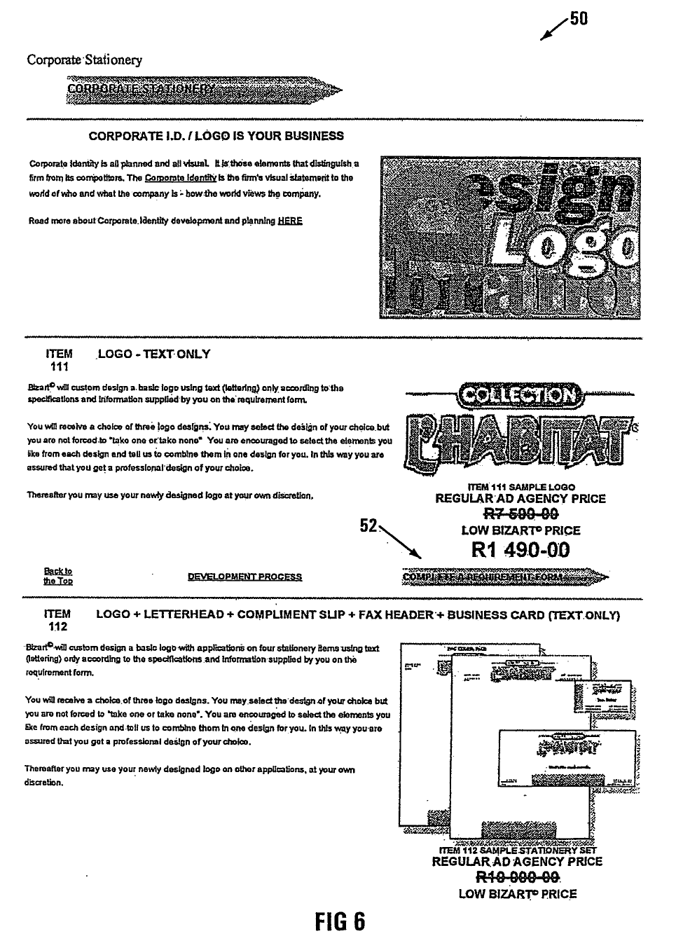

FIG. 6 is a representation of a web page of the web site, which page is entitled “Corporate Stationery”, and is linked to the web pages represented in FIGS. 4 and 5;

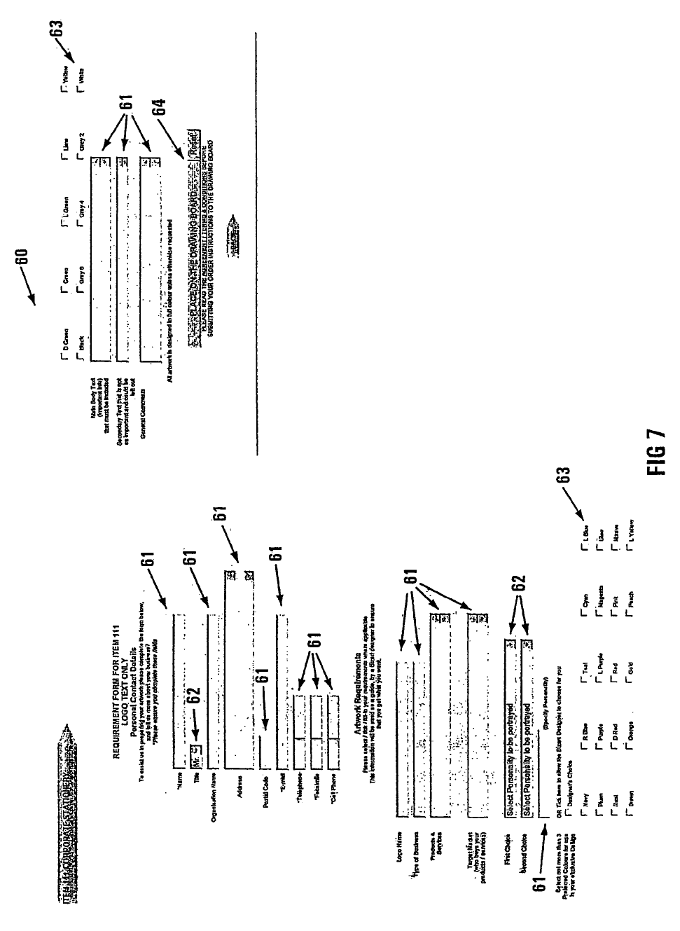

FIG. 7 is a representation of a web page of the web site, which page is entitled “Item 111 Corporate Stationery” and is linked to the web page represented in FIG. 6.

In FIG. 1, reference numeral 10 generally refers to equipment, more specifically a computer system, to supply a design to a potential user of the design, in accordance with the invention. The computer system 10 is used in a method for supplying a design in accordance with the invention. In this example, the method relates to the provision of a design by a design provider (not shown) to a potential user (not shown), with the potential user and the design provider communicating with each other by means of a computer network, more particularly, the internet. Computer 14, is a server computer of the design provider which is connectable to a client computer 1 2, in this case the computer of the potential user, through the internet. As can be seen from FIG. 1, the internet links the computer 12 of the potential user with the computer 14 of the design provider.

A plurality of designers (not shown) have computers 16(a) to 16(e), which are linked to the design provider's computer 14 via the internet.

The computer 14 hosts a web site which includes information supplying means, more specifically an interactive World Wide Web site, whereby a potential user of a design may supply information to the design provider. Various pages of the web site are represented in FIGS. 4 to 7, as set out below.

The server computer 14 has an ordering means, more specifically computer hardware and software, located thereon, which enables the potential user to order a design from the design provider via the internet.

The computer 14 also has a communicating means, more specifically computer hardware and software, located thereon, which enables the design provider to communicate the details of the order from the design provider's computer to the designers' computers 16(a) to 16(e) via the internet.

The computers 16(a) to 16(e) have conveying means, more specifically computer hardware and software, located on each of the said computers, which enables the designers to convey their designs from the designers' computers to the design provider's computer 14 via the internet.

The computer 14 has associating means, more specifically a computer program, located thereon, for associating with the design a use deterring mark to deter unauthorised use of the design by potential users thereof. An example of a use deterring mark is shown in FIG. 2, as set out below.

The computer 14 also has a transmitting means, more specifically computer hardware and software, located thereon, which enables the design provider to transmit the design, with or without the use deterring mark, from the computer 1 4 to the computer 12 via the internet.

It will be appreciated that in a further embodiment of the invention, the computer 12 may belong to an intermediary, such as a retailer.

As will be understood from the further description below, the computer 14 will also have a facility whereby designers may send information to the design provider, so that they may be used by the design provider as designers.

In FIG. 2, reference numeral 17 generally refers to a design in the form of an advertising layout with an associated use deterring mark. The use detering mark is designated by reference numeral 18.

In FIG. 3, reference numeral 19 generally refers to the advertising layout of FIG. 2, without the associated use deterring mark 18 shown in FIG. 2.

It will be appreciated that the design 17 may be transmitted over the internet as a data signal comprising a first set of data elements incorporating the advertising layout 19 and a second set of data elements incorporating the use deterring mark 18.

Referring to FIGS. 4, 5, 6 and 7, reference numeral 20 in FIG. 4 generally refers to a home web page of the web site which is hosted on the design provider's computer 14.

Reference numeral 22 designates an area on the home web page 20 which contains the words “Services & Price Lists”, said area being a link. Reference numeral 34 designates an area on the home web page 20, which area contains the words “Corporate Stationery”, the said area being also a link.

Reference numeral 40 in FIG. 5 generally refers to a web page entitled “Graphic Design Services & Price List” displaying prices for design services. The web page 40 is linked to the home web page 20 by the link 22. Reference numeral 42 designates an area on the web page 40, which area contains the words “Corporate Stationery & Other Applications”, the said area being a link.

Reference numeral 50 in FIG. 6 generally refers to a web page entitled “Corporate Stationery” displaying examples of designs. The web page 50 is linked to the web page 40 by the link 42 and to the home web page 20 by the link 34. Reference numeral 52 designates an area on the web page 50, which area contains the words “Complete a Requirement Form”, the said area being a link.

Reference numeral 60 in FIG. 7 generally refers to a web page entitled “Item 111 Corporate Stationery”. The web page 60 is linked to the web page 50 by the link 52 and has a plurality of input fields 61, selection boxes 62 having a plurality of options (not shown) and toggling check boxes 63. Reference numeral 64 designates an area on the web page 60, which area contains the words “Place on the Drawing Board”, the said area being a link.

The home web page 20 includes links to further web pages (not shown), which the potential user may choose to read.

Reference numeral 26 designates an area on the home web page 20, which area contains the words “About Us”, said area being a link to a web page (not shown) providing information about the design provider.

Reference numeral 28 designates an area on the home web page 20, which area contains the words “What Is Corporate ID?”, said area being a link to a web page (not shown) providing information about branding and marketing.

Reference numeral 30 designates an area on the home web page 20, which area contains the words “How Do I Order?”, said area being a link to a web page (not shown) providing step-by-step instructions for the potential user to follow so as to order a design.

Reference numeral 32 designates an area on the home web page 20 which area contains the words “SafeShop”, said area being a link to another web site (not shown) of an electronic payment service provider (not shown), where electronic payment services are provided.

It will be appreciated that in another embodiment of the invention, the home web page may also have an area being a link to another web page having an information providing means to enable a designer to apply for appointment as a designer for the design provider. The information providing means may include input fields, selection boxes and toggling check boxes to enable a designer to provide details about himself. An electronic file providing means may also be provided to enable the designer to scan documents and attach electronic files, for example curriculum vitae, portfolios, digitised artwork and photographs, in accordance with instructions provided on the web site.

When the potential user wishes to obtain a design, which in the following example shall be a logo, the potential user selects the link 22 on the home web page 20. This causes the web page 40 to be called up. She then selects the link 42. This causes the web page 50 to be called up. Alternatively, she may select link 34 on the home web page 20 which will also cause the web page 50 to be called up. She then selects link 52 which causes the web page 60 to be called up.

She then furnishes information regarding her personal details and details of her artwork requirements by typing the information in the input fields 61, scrolling through the options of the selection boxes 62 and clicking on the appropriate option as well as clicking on one or more of the toggling check boxes 63 to select options represented by the said toggling check boxes. The information which she furnishes includes:
a logo name;
type of business to which the logo shall relate;
products and services provided by the business;
target market of the business;
personality to be portrayed by the logo (first and second choice);
not more than three colours to be used in the logo (alternatively she may indicate that the designer shall choose the colours);
main body text that must be included in the logo;
optional text which the designer may include in the logo at his discretion; and
general comments containing further information regarding the business or further requirements regarding the logo.

She selects the link 64 which will cause her order to be submitted to the design provider and will cause the web site of the electronic payment service provider to be called up, where she will enter her personal and bank account details and the amount to be debited from her bank account (not shown) and credited to the bank account (not shown) of the electronic payment service provider, being one third of the purchase price of the logo. The electronic payment service provider will then notify the design provider of the payment.

Upon receipt of the notification of the payment from the electronic payment service provider, the design provider communicates the details of the order via the internet to the computer 16(a) of a designer (not shown) being one of the plurality of designers (not shown) whose computers 16(a) to 16(e) are linked to the design provider's computer 14 via the internet.

On the basis of the details furnished by the potential user, the designer prepares three different logos and saves the logos in separate electronic files. The designer then conveys the logos in electronic format via the internet to the computer 14 of the design provider. In respect of each logo the design provider checks that the criteria set by the potential user have been met and, when satisfied with the quality thereof, saves the logos in separate electronic files (not shown) for each logo. The design provider runs a computer program (not shown) on the computer 14 which associates a use deterring mark with each logo by superimposing the use deterring mark on the logo and the design provider saves the logos with the associated use deterring marks in further separate electronics file (not shown). The design provider then transmits the logos with their associated use deterring marks via the internet to the potential user's computer 12.

The potential user chooses one of the logos and, if desired, indicates amendments be made to the logo. The potential user then sends the logo with the amendments indicated thereon to the design provider by telefax or electronically scans the logo with the amendments and submits an electronic file generated by the scanning of the logo to the design provider's computer 14 via the internet. The potential user now pays the design provider a further third of the purchase price. This is done by the potential user accessing the design provider's home web page 20 and selecting the link 32 which causes the web site of the electronic payment service provider (not shown) to be called up. Payment of the second instalment of the purchase price is effected by debiting the potential user's bank account and crediting the electronic payment service provider's bank account in the same manner as with the first payment. The electronic payment service provider notifies the design provider of the second payment.

Once the design provider has received notification from the electronic payment service that the second instalment of the purchase price has been paid, he communicates the design, with the amendments indicated thereon, via the internet to the designer's computer 16(a). If the amended design was not forwarded to the design provider in the form of an electronic file, then the design provider will electronically scan the amended design and submit the electronic file generated by the scanning to the designer via the internet.

The designer accordingly amends the design previously furnished by the designer and reconveys the amended design to the design provider's computer 14 via the internet. The design provider saves the logo in a separate electronic file. The design provider again runs the computer program which superimposes a use deterring mark on the logo and saves the amended logo with the use deterring mark in another separate electronic file (not shown). The design provider transmits the amended logo with the associated use deterring mark via the internet to the potential user's computer 12.

Having satisfied herself that the amended logo meets with her approval, the potential user effects payment of the balance of the purchase price in the same manner as she effected payment of the second instalment of the purchase price. The electronic payment service provider notifies the design provider of the third payment.

Once the design provider has received notification from the electronic payment service provider of the third payment, he transmits the logo, without the use deterring mark, via the internet to the potential user's computer 12.

The design provider notifies the electronic payment service provider that the transaction has been completed and the electronic payment service provider then credits the design provider's bank account with the amount of the purchase price.

In this example the use deterring mark is difficult for an unauthorised person to disassociate from the design but easy for the design provider to disassociate from the design.

The invention, as exemplified above, enables designs to be furnished to a potential user for approval so that the potential user has the opportunity to request amendments to the design, while allowing the design provider to secure payment before the final design is released. It also enables the design to be done by designers who may be geographically remote from both the potential user and the design provider. Furthermore, by means of the invention, as exemplified above, designs can be provided in an economical manner.

1. Equipment for supplying a design to a potential user thereof, characterised in that the equipment includes : an associating means for associating with the design a mark to deter unauthorised use of the design by potential users thereof; and a transmitting means for transmitting the design together with the associated use deterring mark to the potential user.

2. Equipment as claimed in claim 1 characterised in that the equipment includes a computer and the associating means includes a computer program.

3. A computer system for supplying a design to a potential user by means of a computer network, characterised in that the system includes an associating means for associating with the design a mark to deter unauthorised use of the design by the potential user; and a transmitting means for transmitting the design together with the use deterring mark to the potential user for approval.

4. The computer system as claimed in claim 3 characterised in that it includes an ordering means whereby the potential user may forward details of an order for the design by means of the computer network to the design provider.

5. The computer system as claimed in claim 4 characterised in that it includes a communicating means for communicating the details of an order for the design from the design provider to a designer by means of the computer network.

6. The computer system as claimed in claim 3, characterised in that it includes a payment facility whereby the potential user may make payment for the design.

7. A method of supplying a design to a potential user thereof, characterised in that it includes the steps of: associating with the design a mark to deter unauthorised use of the design by potential users thereof; and transmitting the design together with the use deterring mark to the potential user for approval.

8. The method as claimed in claim 7, characterised in that it includes the steps of: disassociating the use deterring mark from the design by an authorised person once the potential user has paid for the design; and transmitting to the potential user the design without the use deterring mark.

9. A system for performing the method as claimed in claim 8 characterised in that it includes a data signal comprising
a first set of data elements incorporating the design; and
a second set of data elements incorporating the use deterring mark.

10. A server computerconnectable to a client computer through a network, characterised in that it includes an ordering means whereby a potential user of a design may communicate with a design provider.

11. A server computer connectable to a client computer characterised in that it includes a facility for a designer to apply for appointment as a designer for a design provider.
